(19) United States
(12) Patent Application Publication
(10) Pub. No.: US 2015/0219065 A1
(43) Pub. Date: Aug. 6, 2015

(54) POWER STORAGE SYSTEM

(71) Applicant: Yohei Ishikawa, Kyoto-shi (JP)

(72) Inventor: Yohei Ishikawa, Kyoto-shi (JP)

(21) Appl. No.: 14/419,581

(22) PCT Filed: Aug. 5, 2013
(86) PCT No.: PCT/JP2013/071107

§ 371 Date: Feb. 4, 2015

(30) Foreign Application Priority Data
Aug. 6, 2012 (JP) 2012-174375

(51) Int. Cl. F03B 13/06; H02J 4/00; H02J 17/00

(52) U.S. Cl. CPC F03B 13/06; H02J 17/00; H02J 4/00

(57) ABSTRACT

By outside seawater flowing through a passageway into a water tank having a prescribed volume and installed in the sea with top above the surface of the water, power is generated by a generator provided in the passageway. Therefore, by means of the simple configuration of installing the water tank in water, it is possible to store a prescribed amount of electric power depending on the volume of the water tank and loss is low because the length of the passageway for guiding the seawater into the generator is extremely short compared with conventional systems, making it possible to supply as necessary stable electric power from hydroelectric power generation with good power generation efficiency.

### TECHNICAL FIELD

The present invention relates to a hydroelectric power generation technique for storing a large amount of electric power and providing a stable power supply as necessary.

### BACKGROUND ARTS

Recently, there has been a demand for a technique for storing a large amount of electric power at normal time and providing a stable power supply from the large amount of stored electric power when the usage rate of electric power is high or at time of emergency such as disaster. In Patent Document 1, for example, a power generation system 500 is proposed which, as shown in FIG. 11, utilizes the sea or a lake having adequate water storage as a mammoth dam 501 and generates electric power by using the hydraulic power. Specifically, the power generation system 500 includes a headrace tunnel 502 constructed at a bottom of the dam 501. A water intake 503 is opened in the bottom of the dam 501 as communicated with the headrace tunnel 502. The power generation is performed by rotating a water turbine 504 with the hydraulic power of the water taken in from the water intake 503 and guided into a generator room through the headrace tunnel 502.

After the water is taken in from the water intake 503 and used for rotating the water turbine 504, the water is stored in a water storage tank 505. The water stored in the water storage tank 505 is discharged by a drain pump 506 into the dam 501 through a drain hole 507. The electric power generated by rotating the water turbine 504 is externally transmitted via transmission facilities 508 on the ground. Incidentally, FIG. 11 is a diagram showing an example of the conventional power generation system.

### PRIOR-ART DOCUMENT

### Patent Document

Patent Document 1: Japanese Unexamined Patent Publication No. 2012-26336 (Paragraphs 0001 to 0011, FIG. 1, Abstract and the like)

### SUMMARY OF THE INVENTION

### Technical Problem

By utilizing the sea or lake having an enormous amount of water as the mammoth dam 501, the above-described power generation system 500 stores a large amount of electric power and supplies as necessary a stable electric power from hydroelectric power generation. On the other hand, the construction of the power generation system 500 requires the headrace tunnel 502 and the water storage tank 505 to be built under the ground. This leads to the complication of the configuration of the power generation system 500. The power generation system 500 also has a problem that the water taken in from the water intake 503 suffers a large loss due to friction force and the like while flowing through the headrace tunnel 502 to the water turbine 504 and hence, power generation efficiency is lowered.

The invention has been accomplished in view of the above-described problems and an object thereof is to provide a technique which is adapted to store a predetermined amount of electric power by way of a simple configuration and to provide as necessary a stable supply of high-quality electric power from hydroelectric power generation with high power generation efficiency.

### Solution to the Problem

According to an aspect of the invention for achieving the above object of the invention, a power generation system includes: a water tank installed under water and having a predetermined capacity; a communication passageway formed for communication between the inside and the outside of the water tank; and a generator disposed at the communication passageway, and has a configuration wherein the generator generates electric power from a hydraulic power of water flowing into the water tank via the communication passageway.

In a power generation method according to an aspect of the invention, a generator is disposed at a communication passageway formed for communication between the inside and the outside of a water tank installed under water, and the generator generates electric power from a hydraulic power of water flowing into the water tank.

According to the invention thus constituted, the generator is disposed at the communication passageway formed for communication between the inside and the outside of the water tank installed under water and having the predetermined capacity. The generator generates the electric power from the hydraulic power of outside water flowing into the water tank through the communication passageway. In comparison with rechargeable batteries and capacitors adapted to store power in the form of electric energy or a conventional configuration for hydroelectric power generation, therefore, the invention features the simple configuration adapted to store water always ready for generation of the predetermined amount of electric power corresponding to the capacity of the water tank by virtue of installing the water tank under water. The power generation system of the invention is highly effective not only as a regular power generation system but also as an emergency power source. Further, the power generation system of the invention is reduced in loss because the length of the communication passageway for guiding the water into the generator is far shorter than that of the conventional systems. The power generation system is capable of generating electric power at high efficiency and providing, as necessary, a stable supply of high quality electric power with very little voltage fluctuations or frequency fluctuations.

It is preferred that the water tank is installed under water with an upper end portion thereof exposed from water surface, that the communication passageway is formed in the vicinity of a bottom of the water tank, and that the generator is driven by a difference between water pressures in the water tank and at the outside of the water tank.

If such a configuration is made, in the vicinity of the bottom of the water tank having the predetermined capacity and installed under water with the upper end portion thereof exposed from the water surface, the power generation according to the difference between the pressure on the water surface in the water tank and the pressure on the water surface outside the water tank is performed by the generator disposed at the communication passageway and driven by the difference between the water pressures in the water tank and at the outside of the water tank, in conjunction with the outside water flowing into the water tank through the communication passageway formed for communication between the inside and the outside of the water tank. As compared with the conventional configuration for hydroelectric power generation, therefore, the simple configuration having the water tank installed under water can provide, as necessary, the stable supply of high quality electric power generated at high efficiency and having very little voltage fluctuations or frequency fluctuations.

It is preferred that the power generation system further includes drainage pump for discharging the water from the water tank to the outside.

If such a configuration is made, while the power generation is performed by the generator in conjunction with the water flowing from the outside of the water tank into the water tank through the communication passageway, the level of water in the water tank rises and the difference between the water pressures in the water tank and at the outside of the water tank decreases so that power storage decreases. However, the water accumulated in the water tank is discharged by the drainage pump whereby the level of water in the water tank falls and the difference between the water pressures in the water tank and at the outside of the water tank increases and hence, the predetermined amount of electric power corresponding to the capacity of the water tank can be stored again.

It is further preferred that the power generation system further includes a receiving antenna for receiving electromagnetic waves of a microwave band, and has a configuration wherein the drainage pump is driven by an electric power generated from the electromagnetic waves of the microwave band which are transmitted from another power generation device and received by the receiving antenna.

If such a configuration is made, the electric power generated by another power generation device, for example, is converted to the electromagnetic waves of the microwave band which are transmitted. The transmitted electromagnetic waves of the microwave band are received by the receiving antenna and used to generate the electric power, by which the drainage pump is driven. Thus, the electric power generated by the other power generation device can be stored in the power generation system.

The condition of the electric power generated from the electromagnetic waves of the microwave band transmitted from, for example, a solar power generation device installed in the cosmic space, as the other power generation device, and received by the receiving antenna is affected by voltage fluctuations of the electric power generated by the solar power generation device, a reception condition of the electromagnetic waves received by the receiving antenna and the like. However, such an electric power is practical because such an electric power is used to drive the drainage pump so as to be temporarily stored and thus, is levelled off through conversion to an electric power from hydroelectric power generation. The stable electric power is supplied to the outside of the system.

Further, in a case where reflection means for reflecting the electromagnetic waves of the microwave band, such as a reflecting mirror or reflector antenna, is installed in the cosmic space, for example, the following effect can be achieved. The electric power generated by another power generation system installed in a remote location as the other power generation device is converted to the electromagnetic waves of the microwave band and transmitted. The transmitted electromagnetic waves are received by the receiving antenna via the reflection means installed in the cosmic space and used to generate the electric power, by which the drainage pump is driven. Thus, the electric power generated by the power generation system installed in the remote location can be stored in the power generation system.

It is preferred that the receiving antenna is disposed on the upper end portion of the water tank, which is exposed from water surface.

A need for providing an additional space for locating the receiving antenna is eliminated by disposing the receiving antenna on the upper end portion of the water tank which is exposed from the water surface. Hence, the power generation system can achieve space saving. The transmission distance of a DC power, which is generated by receiving the electromagnetic waves of the microwave band by means of the receiving antenna and used to drive the drainage pump, can be shortened by disposing the receiving antenna on the upper end portion of the water tank. Therefore, the DC power can be reduced in transmission loss.

It is preferred that the drainage pump is driven by an electric power generated from a renewable energy.

If such a configuration is made, the drainage means is driven by the electric power generated from the renewable energy such as solar energy, hydraulic power, wind power, tidal power, wave power, ocean current, geothermal, biofuel and biomass so as to discharge the water from the water tank to the outside of the water tank. Thus, the predetermined amount of electric power corresponding to the capacity of the water tank is stored in the power generation system. The electric power stored in the power generation system is converted to electric power from the hydroelectric power generation capable of the most stable power supply among the power generation methods utilizing the renewable energy. The converted power is supplied to the outside of the system. Even though electric power generated using a renewable energy other than the hydraulic power is in an instable condition due to voltage fluctuations, frequency fluctuations or the like, the instable electric power is once stored by driving the drainage pump to discharge the water from the water tank to the outside and then, is converted to the electric power from the hydroelectric power generation and supplied to the outside of the system. In this manner, the instable electric power can be levelled off to be supplied to the outside in a stable condition.

It is preferred that the renewable energy is solar light or wind power.

Electric power from solar power generation affected by daylight hours, weather and the like and electric power from wind-power generation affected by wind conditions have a high probability of becoming instable due to voltage fluctuations, frequency fluctuations or the like. However, if such a configuration is made, such electric powers are very practical because such an electric power is used to drive the drainage pump so as to be once stored in the power generation system and levelled off through conversion to the electric power from the hydroelectric power generation. Thus, the electric power in the stable condition is supplied to the outside of the system.

It is preferred that a solar panel for generating electric power from the solar light is disposed on the upper end portion of the water tank, which is exposed from the water surface.

A need for providing an additional space for locating the solar panel is eliminated by disposing the solar panel on the upper end portion of the water tank which is exposed from the water surface. Hence, the power generation system can achieve space saving. The transmission distance of a DC power, which is generated by the solar panel and used to drive the drainage pump, can be shortened by disposing the solar panel on the upper end portion of the water tank. Therefore, the DC power can be reduced in transmission loss.

It is preferred that the drainage pump is driven by an electric power from nuclear power generation.

Although the nuclear power generation has a characteristic that it is difficult to adjust output in accordance with power demand, the nuclear power generation is very efficient because a surplus power during night-time when the power demand is low, for example, is used to drive the drainage pump whereby the surplus power from the nuclear power generation is stored in the power generation system. Further, the nuclear power generation is practical because the surplus power stored in the power generation system can be used at time of emergency or during a period of peak demand for electricity.

It is preferred that a plurality of communication passageways are formed in a direction of a height of the water tank and each of the communication passageways is provided with the generator.

If such a configuration is made, the respective outputs from the generators disposed at the water tank in a direction of the height of the water tank vary in response to the rise of the water level in the water tank in conjunction with the inflow of water into the water tank via the respective communication passageways. The driving condition of the respective generators is controlled in response to the change in the level of water stored in the water tank so that the output from the power generation system can be substantially maintained constant despite the variations in the water level of the water tank. For example, the power generation system may be controlled in a manner that in response to the rise of the water level in the water tank, the generators are sequentially driven in ascending order from the deepest generator in the water tank toward the shallowest generator.

It is preferred that the power generation system further includes: an auxiliary water tank installed under water in the vicinity of the water tank as a main water tank; a flow passage formed for communication between the inside and the outside of the auxiliary water tank; and an auxiliary generator which is disposed at the flow passage in relation to the generator at the main water tank as a main generator and which is driven by a difference between water pressures in the auxiliary water tank and at the outside of the auxiliary water tank, and has a configuration wherein when water is stored in the main water tank to above a predetermined water level and an output power from the main generator falls below a predetermined power level, the auxiliary generator generates electric power according to a difference between a pressure on the water surface in the auxiliary tank and a pressure on the water surface outside the auxiliary tank.

If such a configuration is made, when the water is stored in the water tank to above the predetermined water level so that the output from the generator falls below the predetermined power level, the water flows into the auxiliary water tank via the flow passage so that the auxiliary generator generates electric power according to the difference between the pressure on the water surface in the auxiliary water tank and the pressure on the water surface outside the auxiliary water tank. Hence, the system can consistently provide the stable supply of constant output power by adding the output from the auxiliary generator to the output from the main generator.

It is preferred that the power generation system, which has the water tank installed under the sea near a coast line where a nuclear power plant is located, is used as an emergency power source for the nuclear power plant.

If such a configuration is made, the power generation system is installed under the sea and hence is very robust against flood damages such as caused by tsunami as compared with an emergency power system installed on the ground. The power generation system can provide the stable supply of electric power to the nuclear power plant in time of emergency. With the height, the width and the depth of the water tank properly defined, the power generation system can be driven as the emergency power source for much longer periods of time as compared with the conventional emergency power system. Thus, the power generation system can improve the safety of the nuclear power plant.

It is preferred that an opening is formed at the upper end portion of the water tank.

If such a configuration is made, in the event of a tsunami, the water tank allows the tsunami to fall into the water tank through the opening at the upper end portion thereof provided that the water tank has the height, width and depth properly defined and is installed under the sea near the coast line. Therefore, the water tank can reduce damages on the facilities on the ground caused by the tsunami. Further, the energy of the tsunami is consumed very efficiently because the energy of the tsunami is converted to thermal energy through motion of being thrown against an inside wall of the water tank when the tsunami is allowed to fall into the water tank through the opening at the upper end portion thereof.

Further, the power generation system may further include a cover member for openably closing the opening.

If such a configuration is made, the invasion of seawater, rainwater, dusts and the like into the water tank can be prevented by normally closing the opening at the upper end portion of the water tank with the cover member. In the event of a storm surge or tsunami, the seawater is allowed to fall into the water tank by moving the cover member and opening up the opening in the case where the water tank is disposed under the sea. Therefore, the water tank can reduce the damages on the facilities on the ground caused by the storm surge or tsunami.

It is preferred that the water tank is formed of a caisson, and that cross sections of the caisson orthogonal to an inner face and an outer face thereof each have a reinforcing structure where a plurality of polygons are arranged.

If such a configuration is made, the cost of the water tank can be reduced by forming the water tank of the caisson(s) because the caissons can be unitized to form the water tank. Further, the caisson is configured to define a hollow space between the inner face and the outer face thereof and to have the cross sections orthogonal to the inner face and the outer face thereof which each have the reinforcing structure where a plurality of polygons are arranged. Thus, the caisson can be reduced in weight while maintaining the strength. Furthermore, the work period of the water tank can be shortened by forming the water tank using the unitized caissons.

It is also possible to form the water tank by mutually communicating spaces in the plural caissons.

If such a configuration is made, the plural unitized caissons are combined to form the water tank, which permits the capacity of the water tank to be easily changed by changing the number of the caissons.

It is also possible that the plural caissons are arranged with a predetermined spacing therebetween, that the power generation system further includes an elastic member interposed between the caissons, and that each space between the caissons is sealed with the elastic member.

If such a configuration is made, the power generation system can be improved in earthquake resistance because the elastic member such as rubber is interposed between the caissons so that the vibrations can be attenuated by the elastic member. Since the space between the caissons is sealed with the elastic member, the respective outer faces of the caissons can be inspected in the sealed space between the caissons. Hence, the power generation system can be improved in maintainability.

It is preferred that the power generation system further includes a fixing member disposed in bedrock under the water tank, and a connecting member for connecting the fixing member with the water tank.

If such a configuration is made, the fixing member disposed in the bedrock under the water tank and the water tank are connected together by the connecting member so that the water tank can be reliably fixed in position even in a case where the water tank is formed of the caisson reduced in weight, for example.

It is also possible that the power generation system further includes a transmitting antenna for transmitting electromagnetic waves of a microwave band, and has a configuration wherein electric power generated by the generator is converted to the electromagnetic waves of the microwave band, which are transmitted by means of the transmitting antenna.

If such a configuration is made, the electric power generated by the power generation system can be converted to the electromagnetic waves of microwave band so as to be transmitted to another power generation system by means of the transmitting antenna. In a case where reflection means for reflecting the electromagnetic waves of the microwave band, such as a reflecting mirror or reflector antenna, is installed in the cosmic space, for example, the following effect can be achieved. The electric power generated by the power generation system can be transmitted to another power generation system installed in a remote location by transmitting, from the transmitting antenna, the electromagnetic waves of the microwave band to the other power generation system in the remote location via the reflection means installed in the cosmic space.

### Effects of the Invention

According to the invention, the simple configuration having the water tank installed under water is employed to store the predetermined amount of electric power corresponding to the capacity of the water tank. Further, loss is reduced because the passageway to guide the water into the generator is far shorter than the conventional passageway. The stable electric power from the hydroelectric power generation with high efficiency can be supplied as necessary.

### BRIEF DESCRIPTION OF THE DRAWINGS

FIG. 1 is a diagram showing a power generation system according to a first embodiment of the invention;

FIG. 2 is a diagram showing an example of installation location of the power generation system of FIG. 1;

FIG. 3 is a graph showing how electric power generated by utilizing solar light fluctuates in voltage;

FIG. 4 is a diagram showing a power generation system according to a second embodiment of the invention;

FIG. 5 is a chart for illustrating the output from the power generation system of FIG. 2;

FIG. 6 is a diagram showing a power generation system according to a third embodiment of the invention;

FIG. 7 is a diagram showing a power generation system according to a fourth embodiment of the invention;

FIG. 8 is a diagram showing an internal structure of a caisson forming a water tank shown in FIG. 7;

FIG. 9 diagrammatically shows an embankment formed on a sea side of the power generation system of FIG. 7, FIG. 9A showing a top plan view thereof, FIG. 9B showing a sectional view thereof as seen from the front;

FIG. 10 is a diagram showing a power generation system according to a fifth embodiment of the invention; and

FIG. 11 is a diagram showing an example of conventional power generation system.

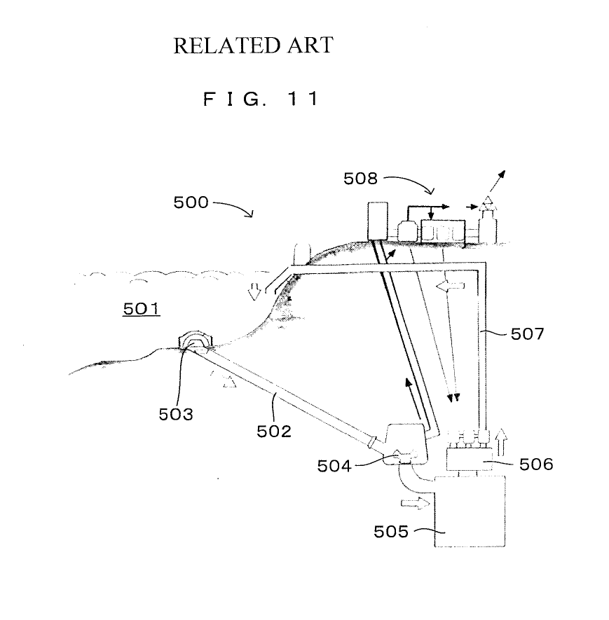

### MODES FOR CARRYING OUT THE INVENTION

### First Embodiment

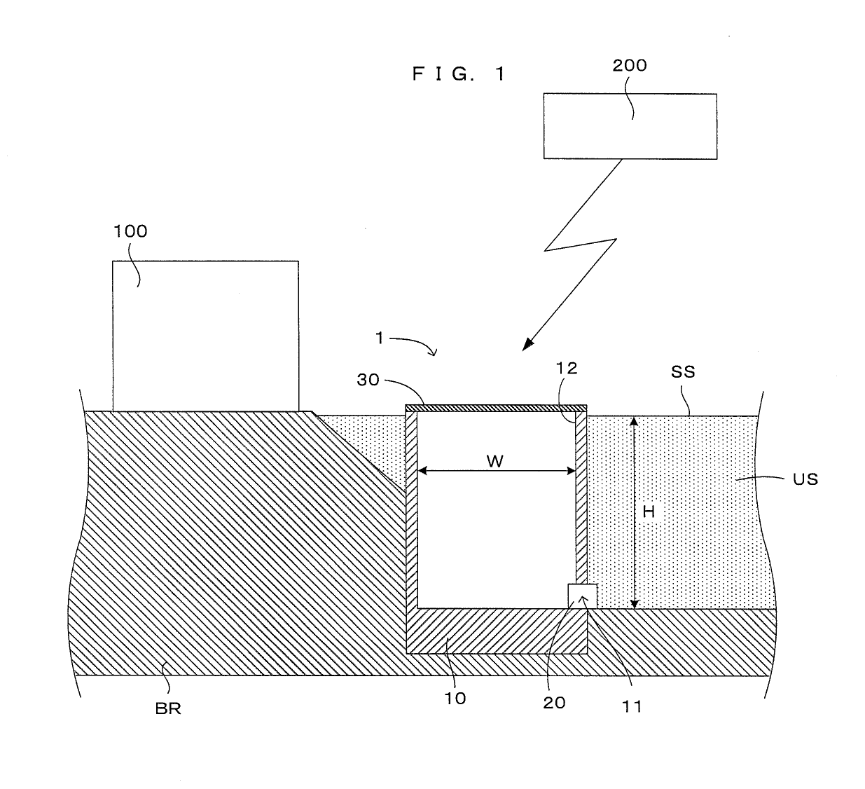

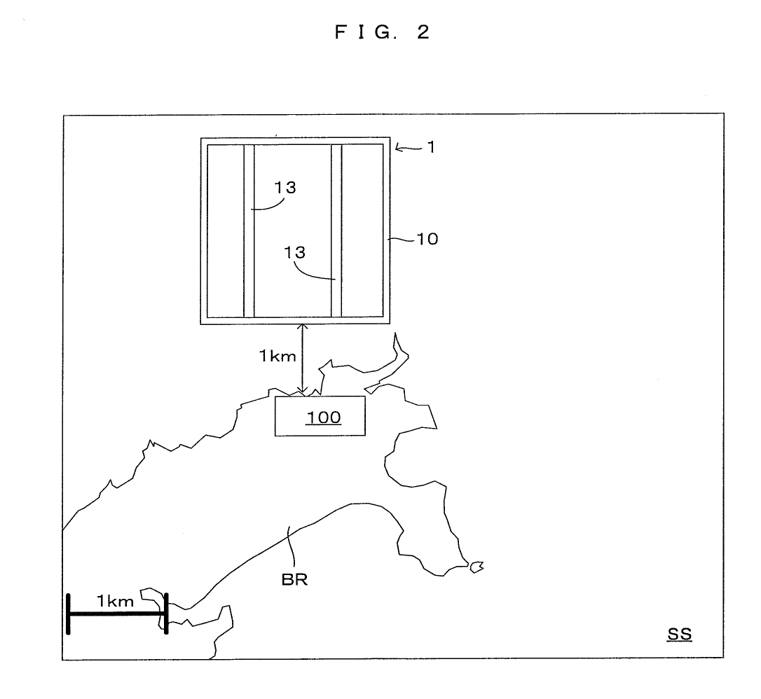

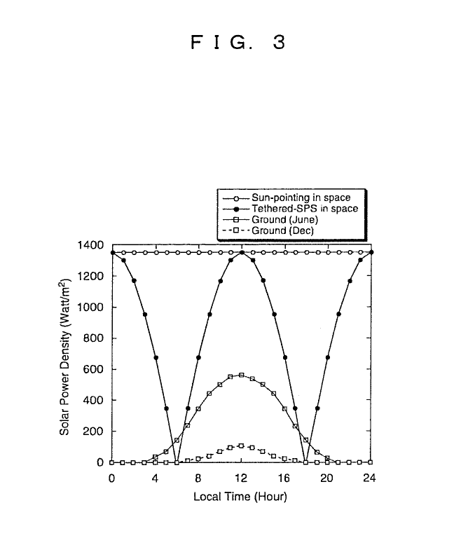

A power generation system according to a first embodiment of the invention is described with reference to FIG. 1 to FIG. 3. FIG. 1 is a diagram showing the power generation system according to the first embodiment of the invention. FIG. 2 is a diagram showing an example of installation location of the power generation system of FIG. 1. FIG. 3 is a graph showing how electric power generated by utilizing solar light fluctuates in voltage.

A power generation system 1 shown in a sectional view of FIG. 1 includes: a water tank 10 installed under the sea US; and a generator 20 installed at a communication passageway 11 formed at a bottom of the water tank 10. Electric power generation is performed by rotating a water turbine disposed at the generator 20 with a hydraulic power of the seawater flowing into the water tank 10 via the communication passageway 11. According to this embodiment, the power generation system 1 is also used as an emergency power source for a nuclear power plant 100.

The water tank 10 is formed in a rectangular parallelepiped configuration having a predetermined capacity and provided with an opening 12 at an upper end portion. The water tank is installed under the sea US with the upper end portion exposed from the sea surface SS. In this embodiment, as shown in FIG. 2, the water tank 10 is formed to have a width W of about 2000 m, a height H of about 200 m and a length (depth) of several kilometers to dozen kilometers and installed along a coast line at place roughly 1 kilometer off the coast where the nuclear power plant 100 is located. In this case, the water tank 10 is fitted in a recess formed by drilling seafloor bedrock BR so as to be rigidly fixed to the floor of the sea.

Further, according to this embodiment, the water tank 10 is increased in strength by partitioning the internal space of the water tank 10 into a plurality of space portions by means of partition members 13. Further, according to this embodiment, as shown in FIG. 2, the partition members 13 are arranged and oriented in parallel to a travelling direction of tsunami substantially perpendicular to a direction of the coast line, for example. If such a configuration is made, the water tank 10 can be increased in strength against the pressure of tsunami.

The communication passageway 11 is formed on the bottom of the water tank 10 for communication between the inside and the outside of the water tank 10.

The generator 20 is disposed at the communication passageway 11 and is driven based on a difference between the water pressures in the water tank and at the outside of the water tank 10. Specifically, the generator 20 is equipped with a water turbine, such as Francis turbine, propeller turbine or diagonal flow water turbine, which is rotated by the hydraulic power of flowing water having a pressure head. The generator 20 generates the electric power according to the difference between pressures on a water surface in the water tank 10 and on a water surface outside the water tank 10 by rotating the water turbine with the hydraulic power of the seawater flowing into the water tank 10 via the communication passageway 11. It is noted that the generator 20 may have any configuration that is adapted to generate the electric power by using the hydraulic power of the seawater flowing into the water tank 10 via the communication passageway 11.

The generator 20 is also adapted to discharge the water from the water tank 10 to the outside by means of the water turbine drivably rotated in the opposite direction to the rotation for electric power generation.

In this embodiment, a receiving antenna 30 for receiving electromagnetic waves of a microwave band is provided in a manner to close the opening 12 at the upper end portion of the water tank 10. Further, a solar power generation device 200 (SPS: Solar Power Satellite) which generates electric power by receiving the solar light is installed in the cosmic space. In the power generation system 1, the water turbine of the generator 20 is drivably rotated in the opposite direction to the rotation for electric power generation by the electric power generated by receiving the electromagnetic waves of the microwave band from the solar power generation device 200 by means of the receiving antenna 30.

It is noted that the communication passageway 11 (generator 20) is provided with unillustrated shutter means (floodgate) such that the communication passageway 11 is switched between a state to permit the inflow of seawater to the communication passageway 11 and a state to inhibit the inflow of seawater to the communication passageway 11 by opening or closing the shutter means as necessary. In this manner, the generator 20 functions as “drainage pump” of the invention.

According to this embodiment, as described above, at the bottom of the water tank 10 having the predetermined capacity and installed under the sea US with the upper end portion thereof exposed from the sea surface, the outside seawater flows into the water tank 10 through the communication passageway 11 formed for communication between the outside and the inside of the water tank 10 whereby the generator 20 disposed at the communication passageway 11 is driven by the difference between the water pressures in the water tank 10 and at the outside of the water tank so as to generate the electric power according to the difference between a pressure on the water surface in the water tank 10 and a pressure on the water surface outside the water tank 10. Hence, a simple configuration having the water tank 10 installed under water is capable of storing a predetermined amount of electric power corresponding to the capacity of the water tank 10. In addition, the configuration is reduced in loss because the length of the communication passageway 11 for guiding the seawater into the generator 20 is far shorter than that of the conventional passageway. Hence, the high-quality electric power from hydroelectric power generation featuring high power generation efficiency and very little voltage fluctuations or frequency fluctuations can be stably supplied as necessary at any time of the year, free of the weather condition and in a very short preparation time.

When the electric power generation is performed by the generator 20 in conjunction with the inflow of the outside seawater to the water tank 10 through the communication passageway 11, a water level in the water tank 10 rises so that the difference between the water pressures in the water tank 10 and at the outside of the water tank decreases and thence, power storage decreases. However, the water accumulated in the water tank 10 is discharged to the outside of the water tank 10 by the water turbine of the generator 20 drivably rotated in the opposite direction to the rotation for electric power generation so that the water level in the water tank 10 sinks and the difference between the water pressures in the water tank 10 and at the outside of the water tank increases. Hence, the predetermined amount of electric power corresponding to the capacity of the water tank 10 can be stored again.

In this case, it is preferred to make a configuration where an electric power generated from a renewable energy is used to drivably rotate the water turbine of the generator 20 in the opposite direction to the rotation for electric power generation. If such a configuration is made, the water turbine of the generator 20 is drivably rotated in the opposite direction by the electric power generated from the renewable energy such as solar energy, hydraulic power, wind power, tidal power, wave power, ocean current, geothermal, biofuel or biomass, thus discharging the seawater from the water tank 10 to the outside of the water tank 10. Hence, the predetermined amount of electric power corresponding to the capacity of the water tank 10 is stored in the power generation system 1. The electric power stored in the power generation system 1 is converted to electric power from the hydroelectric power generation capable of the most stable power supply among the power generation methods utilizing the renewable energy and then is supplied to the outside of the system. Even though electric power generated using a renewable energy other than the hydraulic power is in an instable condition due to voltage fluctuations, frequency fluctuations or the like, the instable electric power is once stored by being used to drive the generator 20 to discharge the water from the water tank 10 to the outside and then, is converted to the electric power from the hydroelectric power generation and supplied to the outside of the system. In this manner, the instable electric power can be levelled off so as to be supplied to the outside of the system in a stable condition.

In this embodiment, the water turbine of the generator 20 is configured to be driven by the electric power generated by utilizing the solar light in the opposite direction to the rotation for electric power generation. Specifically, the embodiment is provided with the receiving antenna 30 disposed on the upper end portion of the water tank 10 for receiving the electromagnetic waves of the microwave band. The electromagnetic waves of the microwave band transmitted from the solar power generation device 200 installed in the cosmic space and generating electric power by receiving the solar light are received by the receiving antenna 30 whereby the electric power is generated for drivably rotating the water turbine of the generator 20 in the opposite direction to the rotation for electric power generation or making the water turbine function as a motor pump.

As indicated by • in FIG. 3 (Susumu Sasaki, et al., “A new concept of solar power satellite: Tethered-SPS”, Acta Astronautica, 60(2006), 153-165), the condition of the electric power generated by receiving, by the receiving antenna 30, the electromagnetic waves of the microwave band transmitted from the solar power generation device 200 installed in the cosmic space is affected by power generation condition of the solar power generation device 200 that varies on the basis of the time-varying incident angle of the solar light against a solar panel, the condition of the electromagnetic wave reception by the receiving antenna 30, and the like. However, the electric power of interest is of practical value, because the electric power of interest is once stored by being used to drive the generator 20 so that the electric power of interest is levelled off through conversion to the electric power from the hydroelectric power generation. Thus, the electric power in the stable condition is supplied to the outside of the system.

A need for providing an additional space for locating the receiving antenna 30 is eliminated by disposing the receiving antenna 30 on the upper end portion of the water tank 10 which is exposed from the water surface SS. Hence, the power generation system 1 can achieve space saving. Further, the transmission distance of a DC power, which is generated by receiving the electromagnetic waves of the microwave band by means of the receiving antenna 30 and used to drive the generator 20 in the opposite direction to the rotation for power generation, can be shortened by disposing the receiving antenna 30 on the upper end portion of the water tank 10. Therefore, the DC power can be reduced in transmission loss.

By the way, the water tank 10 is formed with the opening at the upper end portion thereof and has the height H, the width W and the depth properly defined such that the water tank 10 can assuredly accommodate roughly 800 million tons of seawater. In the event of a tsunami, therefore, the water tank 10 can temporarily withstand the pressure of the tsunami because the water tank is rigidly anchored to the bedrock BR near coast line. In addition, the receiving antenna 30 has a breakable structure so that the receiving antenna 30 is broken by the tsunami so as to allow the tsunami to fall into the water tank 10 through the opening 12 at the upper end portion. Therefore, the water tank can reduce damages on the facilities on the ground caused by the tsunami.

Provided that a tsunami having a wave height of about 6.8 m as determined at place off the coast where the nuclear power plant 100 is located has a wave length of 40.2 km, the volume of seawater rushing to the coast on a per-meter basis is about 68,300 m³ (=6.8 m×40.2 km×0.5 (sinusoidal wave)×0.5 (upper half)). That is, about 683 million tons of seawater (=68.300 m³×10,000 m) rushes to 10 km of coast line. However, the water tank 10 has the height H, the width W and the depth properly defined to ensure that the water tank can assuredly accommodate the seawater on the order of 800 million tons. Therefore, the seawater rushing to the coast is allowed to fall into the water tank 10.

When the tsunami collides against the water tank 10, a water pressure of about 75.9 tons per meter is applied to the water tank 10. However, the water tank 10 is rigidly anchored to the bedrock BR as shown in FIG. 1 and hence, the water tank is capable of reliably receiving the water pressure of the tsunami by way of the drag of the bedrock BR. The tsunami has a velocity ν of about 44.2 m/sec ((g×h)^{1/2}=(9.8×200)^{1/2}) as determined at a depth of 200 m. The energy of the tsunami is consumed in the temperature rise of the seawater which, when allowed to fall into the water tank 10, is thrown against an inside wall of the water tank 10 and received by the water tank by way of the drag of the bedrock BR.

Specifically, the energy of the tsunami is consumed by raising the seawater temperature by about 0.7° by applying an energy of 0.69 cal (=(ν^{2/2}+g·h)/4.2 (J/cal)) to 1 cc (1 gram) of seawater. Thus, the energy of the tsunami is consumed by allowing the tsunami to fall into the water tank 10 and besides, the seawater rushing to the coast is accommodated in the water tank 10. Therefore, the damages on the facilities on the ground such as the nuclear power plant 100 caused by the tsunami can be assuredly reduced.

According to the above-described embodiment, the water tank 10 is installed under the sea US near the coast where the nuclear power plant 100 is located such that the use of the power generation system 1 as the emergency power source for the nuclear power plant 100 is implemented. As compared with an emergency power system on the ground, the power generation system 1, which is installed under the sea US as described above, is very robust against flood damage such as caused by tsunami and is capable of stable supply of electric power to the nuclear power plant 1 in time of emergency.

As described above, the water tank 10 has the height H, width W and depth properly defined so as to store electric power equivalent to 60 days' power consumption for about 0.74 million households in a case where the amount of electric power consumed per household is on the order of 310 kw/h, for example. As compared with the conventional emergency power system, therefore, the power generation system 1 can be driven as the emergency power source for much longer periods of time, thus contributing to the safety improvement of the nuclear power plant 100.

Since the power generation system is adapted to generate the electric power by using the seawater alone, there is no fear of marine pollution.

As described above, the most of the energy of the tsunami is consumed in raising the temperature of the seawater, which is allowed to fall into the water tank 10. Even in a case where the water tank 10 is destroyed by the tsunami, therefore, damages to the coastal areas caused by the tsunami can be notably reduced.

The water tank 10 is disposed under the sea in a manner that a top surface of the water tank 10 is substantially flush with the sea surface SS whereby the water tank can preserve the scenery as local tourism resources and accomplish coexistence with marine resources. Since the water tank 10 is installed under the sea US in contrast to a conventional hydroelectric dam installed in the mountains, the power generation system 1 of all-weather type capable of generating electric power during a long spell of dry weather can be provided. Further, the power generation system 1 which is less vulnerable to floods such as storm surge or tsunami and highly resistant to any disasters can also be provided.

### Second Embodiment

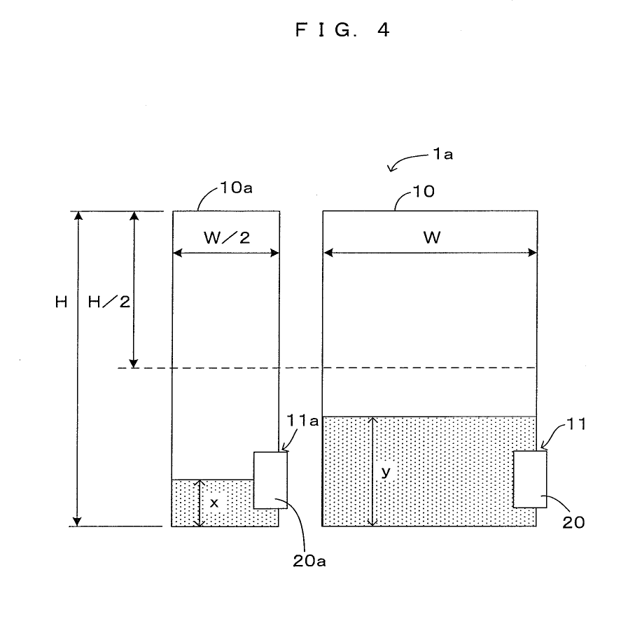

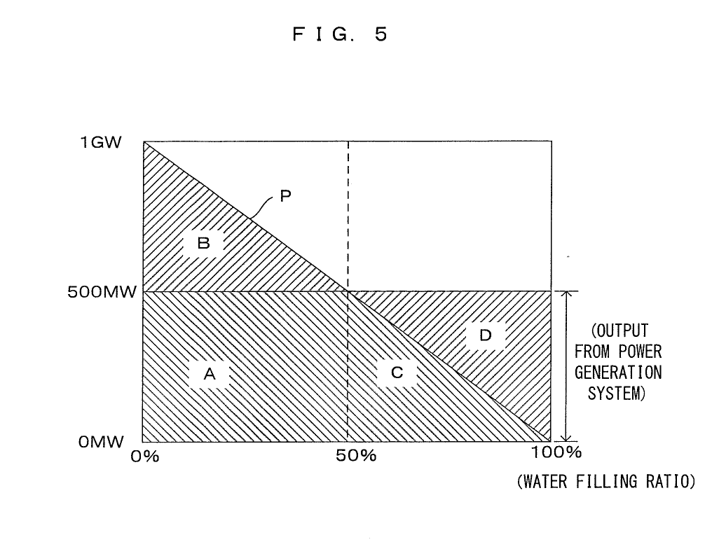

A power generation system according to a second embodiment of the invention is described with reference to FIG. 4 and FIG. 5. FIG. 4 is a diagram showing the power generation system according to the second embodiment of the invention. FIG. 5 is a chart for illustrating the output from the power generation system of FIG. 4.

This embodiment differs from the above-described first embodiment in that, as shown in FIG. 4, a power generation system 1a includes the water tank 10 as a main water tank and an auxiliary water tank 10a disposed in the vicinity of the water tank 10. The auxiliary water tank 10a is so configured as to have half the capacity of the water tank 10. The other components are the same as those of the above-described first embodiment and thence, are indicated by the same reference signs, the description of which is dispensed with.

At a bottom of the auxiliary water tank 10, a flow passage 11a is formed for communication between the inside and the outside of the auxiliary water tank 10a. While the generator 20 of the main water tank 10 serves as a main generator, an auxiliary generator 20a which is driven based on a difference between the water pressures in the auxiliary water tank 10a and at the outside of the auxiliary water tank 10a is provided at the flow passage 11a. The auxiliary generator 20a generates electric power according to a difference between a pressure on a water surface in the auxiliary water tank 10a and a pressure on a water surface outside the auxiliary water tank 10a when the water is stored in the water tank 10 to above a predetermined water level so that the output from the generator 20 falls below a predetermined power level.

The generator 20 disposed at the water tank 10 has the maximum generation capacity of 1 GW, as indicated by a straight line P in FIG. 5. The output of the generator decreases in proportion to the increase in the filling ratio y of water into the water tank 10 or the decrease in the difference between the water pressures in the water tank 10 and at the outside thereof. In this embodiment, the output of the power generation system 1a is set to a predetermined power (e.g., 500 MW). In a case where the output of the generator 20 exceeds the predetermined power, out of the output from the generator 20, an output corresponding to the predetermined power (region A in FIG. 5) is outputted as the output from the power generation system 1a.

Out of the output from the generator 20, a surplus power to the predetermined power (region B in FIG. 5) is used to drivably rotate the auxiliary generator 20a of the auxiliary water tank 10a in the direction opposite to the rotation for electric power generation so that the seawater is discharged from the auxiliary water tank 10a while the electric power is stored. When the water is stored in the water tank 10 to above the predetermined water level (the water filling ratio y is above 50%) and the output from the generator 20 falls below the predetermined power level, the seawater is allowed to flow into the auxiliary water tank 10a via the flow passage 11a so that the auxiliary generator 20a generates the electric power according to the difference between the pressure on the water surface in the auxiliary water tank 10a and the pressure on the water surface outside the auxiliary water tank 10a.

The power generation system 1a is configured to output the predetermined electric power by adding the output from the auxiliary generator (region D in FIG. 5) to the output from the generator 20 (region C in FIG. 5). Specifically, when the filling ratio y of water into the water tank 10 is less than 50%, the electric power is stored while the surplus power from the generator 20 is used to discharge the seawater from the auxiliary water tank 10a. When the filling ratio y of water into the water tank 10 is 50% or more, a shortfall of the output from the generator 20 is covered by the electric power generated by the auxiliary generator 20a according to the filling ratio x of water into the auxiliary water tank 10a. It is preferred to configure the power generation system in a manner that the filling ratio x of water into the auxiliary water tank 10a is set to 0% when the filling ratio y of water into the water tank 10 is 50%.

If such a configuration is made, when the seawater is stored in the water tank 10 to above the predetermined water level so that the output from the generator 20 falls below the predetermined power level, the seawater flows into the auxiliary water tank 10a via the flow passage 11a so that the auxiliary generator 20a generates the electric power according to the difference between the pressure on the water surface in the auxiliary water tank 10a and the pressure on the water surface outside the auxiliary water tank 10a. Hence, the system can consistently provide the stable supply of constant electric power by adding the output from the auxiliary generator 20a to the output from the generator 20.

### Third Embodiment

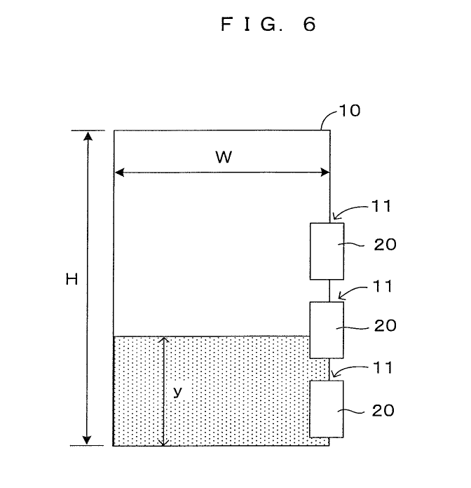

A power generation system according to a third embodiment of the invention is described with reference to FIG. 6. FIG. 6 is a diagram showing the power generation system according to the third embodiment of the invention.

This embodiment differs from the above-described first embodiment in that, as shown in FIG. 6, a plurality of communication passageways 11 are formed in a direction of the height H of the water tank 10 and each of the communication passageways 11 is provided with the generator 20. The other components are the same as those of the above-described first embodiment and thence, are indicated by the same reference signs, the description of which is dispensed with.

If such a configuration is made, the respective outputs of the generators 20 disposed in a direction of the height H of the water tank 10 vary in response to the increase in the filling ratio y of water into the water tank 10 in conjunction with the inflow of seawater into the water tank 10 via the respective communication passageways 11. The driving condition of the respective generators 20 is controlled in response to the change in the level of seawater stored in the water tank 10 whereby the output from the power generation system 1 can be substantially maintained constant despite the fluctuations in the water level of the water tank 10. For example, the power generation system may be controlled in a manner that in response to the increase in the water level of the water tank 10, the generators 20 are sequentially driven in ascending order from the lowest generator 20 in the water tank 10 toward the highest generator 20.

### Fourth Embodiment

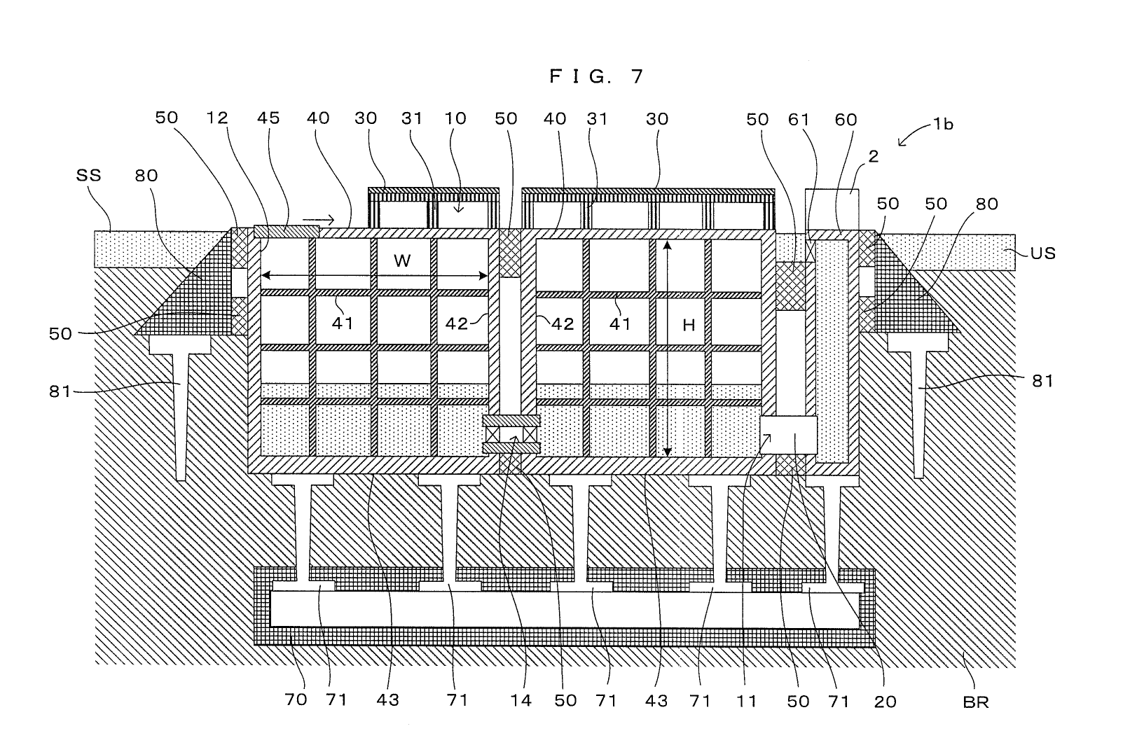

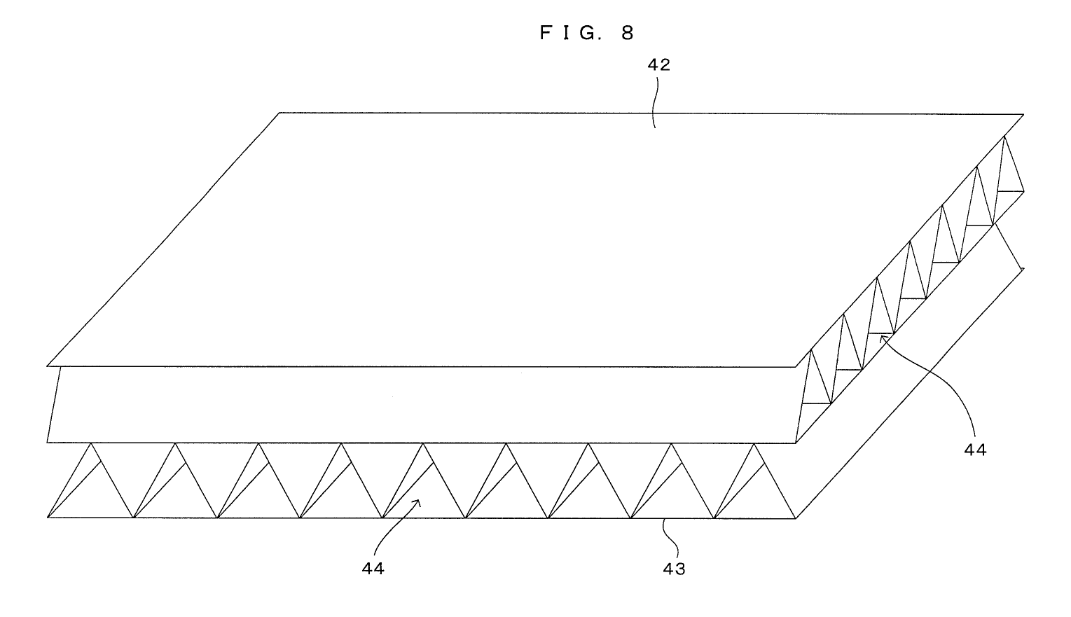

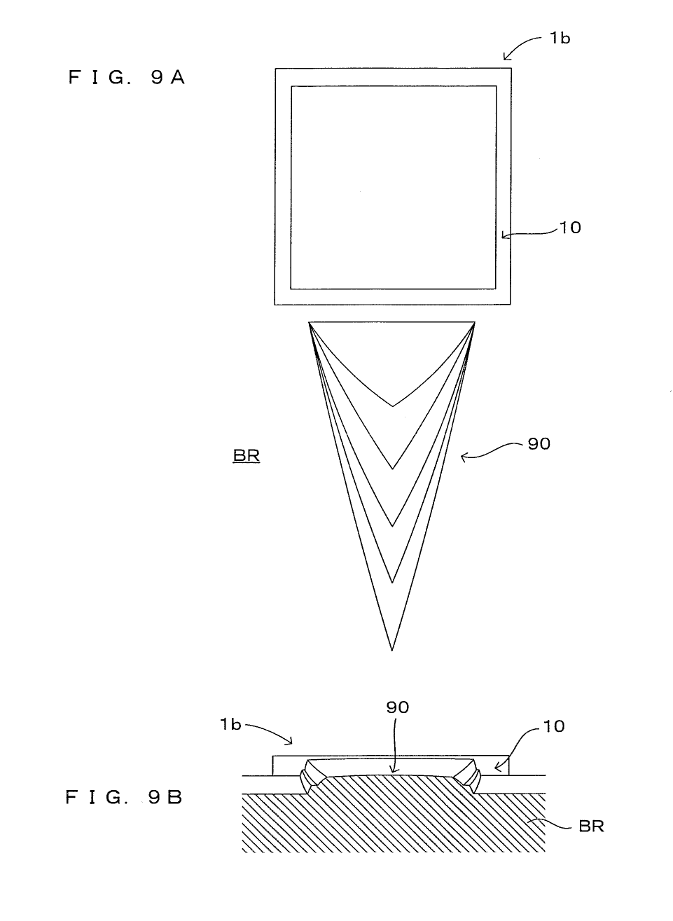

A power generation system according to a fourth embodiment of the invention is described with reference to FIG. 7 and FIG. 8. FIG. 7 is a diagram showing the power generation system according to the fourth embodiment of the invention. FIG. 8 is a diagram showing an internal structure of a caisson of FIG. 7. FIG. 9 diagrammatically shows an embankment formed on a sea side of the power generation system of FIG. 7, FIG. 9A showing a top plan view thereof, FIG. 9B showing a sectional view thereof as seen from the front on the offshore side.

This embodiment differs from the above-described first embodiment in that, as shown in the sectional view of FIG. 7, the water tank 10 of a power generation system 1b is formed by intercommunicating spaces in two caissons 40 by means of a communication path 14. Further, the communication path 14 for intercommunication between the spaces in the caissons 40 is provided with shutter means and a drainage pump. Similarly to the above-described first embodiment, the water tank is installed along the coast line at place roughly 500 meters to one kilometer off the coast. The other components are the same as those of the above-described first embodiment and thence, are indicated by the same reference signs, the description of which is dispensed with.

The caisson 40 according to this embodiment is formed of iron and has a cubic configuration having a width W of about 200 m, a height H of about 200 m and a depth of about 200 m. In the caisson 40, as shown in FIG. 7, reinforcing pillars 41 having a diameter of about 2 m are arranged at intervals of about 50 m. As shown in FIG. 8, the caisson 40 is configured to define a hollow space between an inner face 42 and an outer face 43, the space forming a gap of about 4 m. Cross sections orthogonal to the inner face 42 and the outer face 43 each have a reinforcing structure where a plurality of polygons are arranged. While the reinforcing structure 44 of this embodiment has a trussed configuration, the reinforcing structure 44 may have any configuration such as a honeycomb configuration.

The individual caissons 40 are arranged with a predetermined spacing therebetween while an elastic member 50 such as rubber is interposed between the caissons 40. Further, the space between the caissons 40 is sealed with the elastic member 50. It is preferred that the elastic member 50 is formed of rubber excellent in corrosion resistance in seawater.

At an upper end portion of the caisson 40 disposed on the offshore side (the caisson 40 disposed on the left-hand side as seen in FIG. 7), the opening 12 having a width of about 25 m and a depth of about 200 m is formed along the left side of the upper end portion of the caisson 40 or the side thereof opposed to the sea. The opening 12 is provided with a slide door 45 (equivalent to a “cover member” of the invention) for openably closing the opening 12. The slide door 45 is so formed as to have a width of about 25 m and a depth of about 200 m. The opening 12 is normally closed by the slide door 45. As necessary, the opening 12 is opened by slidably moving the slide door 45 in a direction of the arrow in FIG. 7.

An intake tower 60 adjoins the caisson 40 disposed on the land side or the right-hand side as seen in FIG. 7 as spaced a predetermined distance from the caisson 40. The intake tower 60 is provided with shutter means 61 in the vicinity of the sea surface SS. The seawater taken into the intake tower 60 through the shutter means 61 flows into the caisson 40 through the passageway 11 provided with the generator 20. The intake tower 60 is formed by arranging caissons under the sea, which caissons are configured the same way as the caisson 40. Further, the elastic member 50 is interposed between the caisson 40 and the intake water 50 such that space between the caisson 40 and the intake tower 60 is sealed with the elastic member 50.

As shown in FIG. 7, a shield tunnel 70 (equivalent to a “fixing member” of the invention) is formed by a shield tunneling method in the bedrock BR under the water tank 10. The water tank 10 and the intake tower 60 are fixed in position by connecting the water tank 10 (caissons 40) and the intake tower 60 with the shield tunnel 70 by means of a connecting member 71. It is preferred to form the shield tunnel 70 in the bedrock BR at a depth of about 100 m to about 150 m such that the bedrock BR is prevented from collapsing under the weight of the water tank 10 filled up with the seawater or that the bedrock BR can resist against the buoyancy of the water tank 10 (the caissons 40). In earth and sand having a specific gravity of 2, for example, the shield tunnel 70 may be formed at a depth of about 100 m. In earth and sand having a specific gravity of 1.5, for example, the shield tunnel 70 may be formed at a depth of about 133 m.

A breakwater 80 is disposed in a manner to enclose the water tank 10 and the intake tower 60. The breakwater 80 is anchored to the bedrock BR by means of piles 81. The elastic member 50 is interposed between the breakwater 80 and the water tank 10 and between the breakwater 80 and the intake tower 60.

A control tower 2 is disposed atop the intake tower 60. The shutter means and drainage pump disposed at the communication path 14 for communication between the spaces in the caissons 40, the generators 20 disposed in the passageway 11 and the shutter means 61 disposed at the intake tower 60 are controlled by the control tower 2.

A support member 31 having a height of about 25 m is disposed on the respective top surfaces of the caissons 40. The receiving antenna 30 is fixed on the support member 31. Alternatively, the solar panel in place of the receiving antenna 30 may be disposed on the support member 31 such that the electric power generated by the solar panel is used to drive the drainage pump for discharging the seawater from the water tank 10.

As shown in FIG. 9A and FIG. 9B, an embankment 90 for guiding a storm surge or tsunami toward the water tank 10 is formed on the offshore side or at the underside of the power generation system 1b by utilizing earth and sand produced when the bedrock BR was drilled to dispose the water tank 10. The embankment 90 is formed in a configuration tapered toward the offshore, as shown in FIG. 9A, and centrally banked in crest shape as seen from the front on the offshore side, as shown in FIG. 9B.

This embodiment can achieve not only the same effect as that of the above-described first embodiment but also the following effects. Since the slide door for openably closing the opening 12 is provided, the opening 12 formed at the upper end portion of the water tank 10 (caisson 40) is normally closed by the slide door 45 whereby the invasion of seawater, rainwater, dusts and the like into the water tank 10 can be prevented.

In the event of a storm surge or tsunami, the seawater is allowed to fall into the water tank 10 by slidably moving the slide door 45 disposed on the offshore side of the water tank 10 (caisson 40) and opening up the opening 12. Therefore, the damages on the facilities on the ground caused by the storm surge or tsunami can be reduced.

The water tank 10 is formed using the caissons 40 formed of iron such that the caissons 40 can be unitized to form the water tank 10. Therefore, the water tank 10 can be reduced in cost. The caisson 40 is configured to define the hollow space between the inner face 42 and the outer face 43. Further, the caisson 40 is configured such that the cross sections orthogonal to the inner face 42 and the outer face 43 have the reinforcing structure 44 where a plurality of polygons are arranged. Hence, the caisson 40 can be reduced in weight while maintaining the strength thereof. Therefore, the work period of the work tank 10 can be shortened by transporting the light-weight caissons 40 unitized and fabricated at the facilities on the ground to an offshore construction site and forming the water tank 10.

The water tank 10 is formed by combining the pair of unitized caissons 40 having the internal spaces thereof communicated with each other. The capacity of the water tank 10 can be easily changed by changing the number of the caissons 40.

In the case where two or more caissons 40 are combined to form the water tank 10, the following effects can be achieved. Since the shutter means and the drainage pump are disposed at the communication path 14 for communication between the internal spaces of the caissons 40, the inflow of water into some of the caissons 40 is inhibited by closing the shutter means and performing drainage by the drainage pump. Thus, the caissons 40 with the water inflow inhibited can be inspected while operating the power generating system 1b using the other caissons 40. Therefore, the power generation system 1b can be improved in maintainability.

Even though some of the plural caissons 40 are damaged, the inflow of water into the damaged caissons, for example, is inhibited so that the water tank 10 can be repaired by only repairing the damaged caissons while keeping operating the power generation system 1b by using the other normal caissons 40. Hence, the power generation system 1b can be improved in robustness. Further, the capacity of the water tank 10 can be easily changed by inhibiting the inflow of seawater into some of the caissons 40 or by adjusting the water level of each of the caissons 40. Therefore, the generation profile of the power generation system 1b can be easily changed.

The elastic member 50 such as rubber is interposed between the caissons 40 and hence, the vibrations can be attenuated by the elastic member 50. The power generation system 1b can be improved in earthquake resistance. Further, the spaces between the caissons 40 are sealed with the elastic member 50. In the sealed space between the caissons 40, therefore, the respective outer faces 43 of the caissons 40 can be inspected. Thus, the power generation system 1b can be improved in maintainability.

If there is no need for sealing the spaces between the caissons 40, it is only necessary to interpose an elastic member such as spring or damper between the caissons 40. With such a measure, the vibrations can be attenuated by the elastic member. Hence, the power generation system 1b can be improved in earthquake resistance. Further, plural types of elastic members such as spring and rubber may also be used in combination for sealing the spaces between the caissons 40. It is also possible to simply seal the spaces between the caissons 40 with a member such as concrete or iron. Such a measure also permits the outer faces 43 of the caissons 40 to be inspected in the respective sealed spaces between the caissons 40. Therefore, the power generation system 1b can be improved in maintainability.

Even in the case where the water tank 10 is formed of the light-weight caissons 40, for example, the water tank 10 can be reliably anchored to the bedrock BR by connecting the water tank 10 (the caissons 40) and the intake tower 60 with the shield tunnel 70 disposed in the bedrock BR under the water tank 10 by means of the connecting member 71. In this manner, the water tank 10 is fixed in position without relying on the self-weight of the water tank 10 but by allocating the function to fix the water tank 10 to the shield tunnel 70 and the connecting member 71 which are rigidly anchored in the bedrock BR. This permits the weight reduction of the caisson 40 forming the water tank 10. By achieving the weight reduction of the caisson 40, therefore, transportation cost for the caisson 40 can be reduced. In addition, work period can be shortened and cost reduction can be achieved.

Further, as shown in FIG. 7, the connecting member 71 connecting the shield tunnel 70 with the water tank 10 can be inspected in the space of the shield tunnel 70. Therefore, the power generation system 1b can be improved in maintainability. Incidentally, more than one shield tunnels 70 may be disposed in the bedrock BR depending upon the footprint of the water tank 10.

The earth and sand resulting from the drilling of the bedrock BR for disposing the water tank 10 is utilized to form the embankment 90 for guiding the storm surge or tsunami toward the water tank 10 on the offshore side of the power generation system 1b. Thus, the earth and sand can be used in a very efficient manner to achieve effective use of resources.

### Fifth Embodiment

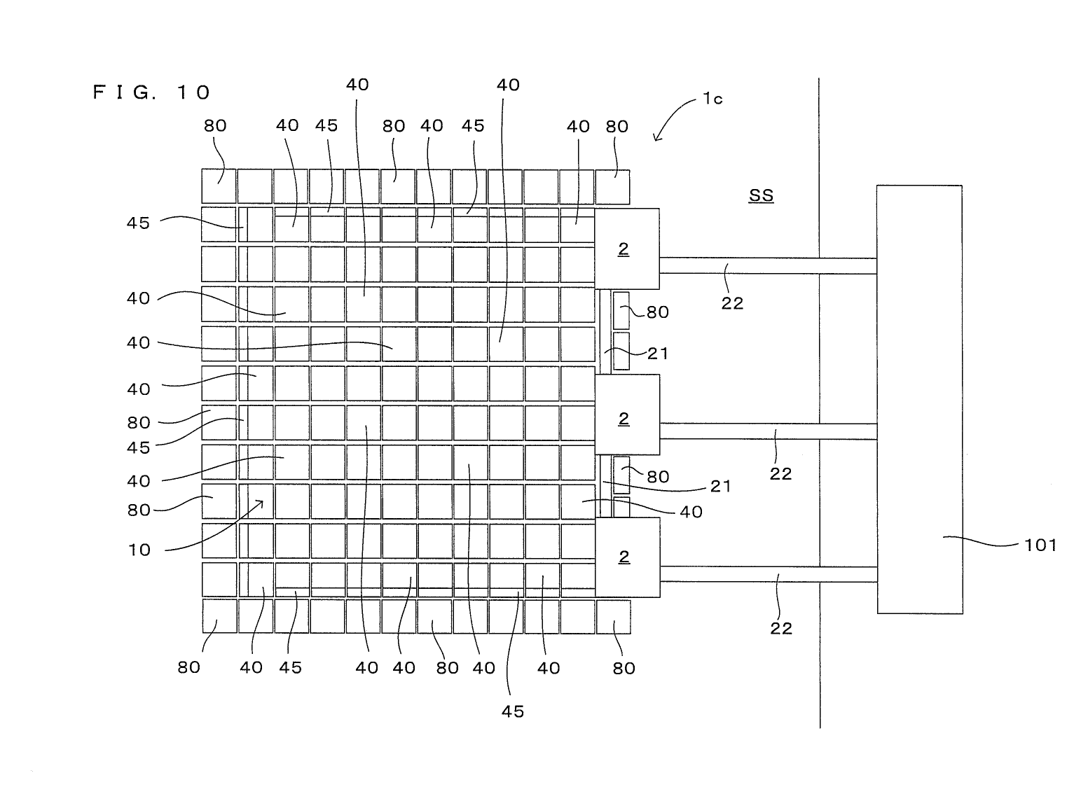

A power generation system according to a fifth embodiment of the invention is described with reference to FIG. 10. FIG. 10 is a diagram showing the power generation system according to the fifth embodiment of the invention.

A power generation system 1c according to this embodiment differs from the above-described fourth embodiment in that, as shown in a plan view of FIG. 10, the water tank 10 is formed of 100 caissons 40 which are arranged in a 10×10 matrix form and the internal spaces of which are mutually communicated. A thermal power plant 101 is installed ashore. The other components are the same as those of the above-described fourth embodiment and thence, are indicated by the same reference signs, the description of which is dispensed with.

As shown in FIG. 10, out of the caissons 40 forming the water tank 10, the caissons 40 on the outermost sides except for those on the right-hand side as seen in the figure have the same slide doors 45 as those of the above-described fourth embodiment mounted on the sea-sides of the upper end portions thereof. The control towers 2 are disposed at three places in adjoining relation with the shore side of the water tank 10. The caissons 40 disposed in correspondence to each of the control towers 2 are each provided with the generator not shown.

Similarly to the above-described fourth embodiment, the breakwater 80 is disposed around the water tank 10.

The control towers 2 are connected with each other via a cable line 21. Each of the control towers 2 is connected to the thermal power plant 101 via a cable line 22 such that a nighttime surplus power from the thermal power plant 101, for example, is used to drive the unillustrated drainage pump so as to discharge the seawater from the water tank 10. In this embodiment, as well, the power generation system 1c is also used as an emergency power source for the thermal power plant 101.

Although not shown in the figure, the receiving antenna or the solar panel is disposed atop the water tank 10 just as in the above-described fourth embodiment. Similarly to the above-described fourth embodiment, a plurality of shield tunnels (not shown) for anchoring the caissons 40 forming the water tank 10 are disposed in the bedrock under the water tank 10. The shield tunnels are connected to the individual caissons 40 via connecting means.

This embodiment can achieve the same effects as in the above-described fourth embodiment.

It is noted that the present invention is not limited to the above-described embodiments and a variety of changes or modifications other than the above can be made thereto without departing from the spirit or essential characteristics thereof. The components in the above-described embodiments may be combined in any ways. For example, the power generation systems according to the above-described embodiments are constructed by installing the water tank under the sea. However, a power generation system may also be constructed by installing the water tank in a lake.

In the above-described first embodiment, the above-described receiving antenna 30 may be replaced by the solar panel which is disposed at the upper end portion of the water tank 10 in a manner to close the opening 12. Such a configuration is very practical. As indicated by □ in FIG. 3, the electric power from the solar power generation affected by daylight hours, weather and the like is used to drive the generator 20 in the opposite direction to the rotation for electric power generation so as to be temporarily stored in the power generation system 1 whereby the electric power from the solar power generation is levelled off through conversion to the electric power from hydroelectric power generation. Thus, the stable electric power is supplied to the outside of the system. It is noted that the solar panel also has the breakable structure and hence, the same effect as described above can be achieved in the event of a tsunami.

The solar panel is disposed on the upper end portion of the water tank 10 that is exposed from the water surface, which negates the need for providing an additional installation place for the solar panel. Therefore, the power generation system 1, 1b, 1c can achieve space saving. The transmission distance of the DC power generated by the solar panel and used to drive the drainage pump (generator 20) can be shortened by disposing the solar panel on the upper end portion of the water tank 10. Therefore, the transmission loss of the DC power can be reduced.

The electric power for driving the generator 20 (drainage pump) in the opposite direction to the rotation for electric power generation may be generated by any means. If the drainage pump is driven by an electric power from wind power generation, for example, the instable electric power from the wind power generation affected by the wind conditions and susceptible to voltage fluctuations and frequency fluctuations is used to drive the drainage pump whereby the resultant electric power is temporarily stored in the power generation system. Thus, the instable electric power is levelled off through conversion to the electric power from the hydroelectric power generation. This is a very practical approach because the stable electric power is supplied to the outside of the system.

The drainage pump may be driven by an electric power from nuclear power generation. While the nuclear power generation has a characteristic that it is difficult to adjust output in accordance with power demand, a surplus power during night-time when the power demand is low is used to drive the drainage pump whereby the surplus power from the nuclear power generation is stored in the power generation system. This is a very efficient approach because the surplus power from the nuclear power generation can be stored in the power generation system. This is also a very practical approach because the surplus power stored in the power generation system can be used at time of emergency or during a period of peak demand for electricity.

In a case where the drainage pump is driven by using a surplus power from a power plant using another energy such as a thermal power plant or hydroelectric power plant, as well, the surplus power can be stored in the power generation system and thence used very efficiently just as in the case of the nuclear power generation. This is also a very practical approach because the surplus power stored in the power generation system can be used at time of emergency or during a period of peak demand for electricity.

In a case where a renewable energy other than the solar light is used in the above-described first embodiment, the opening at the upper end portion of the water tank need not necessarily be closed. The receiving antenna or the solar panel may also be disposed on the ground or on the sea in adjoining relation with the water tank.

While the auxiliary water tank is composed of a separate member from the main water tank in the above-described second embodiment, the main water tank and the auxiliary water tank may also be formed by dividing the internal space of one water tank into two space portions with a partitioning member.

While the generator 20, 20a functions as the “drainage pump” of the invention in the above-described embodiments, a drainage pump or the like independent from the generator 20, 20a and functioning as the “drainage pump” may also be provided at the water tank 10, 10a. If such a configuration is made, the electric power generation at a constant power output can be consistently provided by driving the drainage pump during the electric power generation in a manner that the seawater is discharged from the water tank at the same rate as the rate of inflow of seawater into the water tank. In a case where the DC power from the solar power generation is used to drive the drainage pump at this time, for example, the drainage pump may be composed of a DC motor or the like driven by the DC power. Such a configuration is efficient because the drainage pump can be driven using the DC power from the solar power generation, without converting the DC power to an AC power.

While the electric power for driving the drainage pump may be generated by any means such as solar power generation, wind power generation, nuclear power generation and thermal power generation, as described above, the drainage pump may be adapted to be driven by electric power from more than one of these power generation means. If such a configuration is made, even though one of the power generation means fails, the drainage pump can be driven by the electric power from the other power generation means.

While the power generation system of the invention has been described by way of examples of the configuration where the power generation system is also used as the emergency power source for the nuclear power plant or the thermal power plant, the mode of use of the power generation system of the invention is not limited to the above-described examples. The power generation system of the invention may be used to construct a power plant which supplies the electric power to common households or factories. Alternatively, the power generation system of the invention with the emptied water tank may be installed under the sea or in the lake such that the power generation system of the invention is constructed as the emergency power source to be used when other power-generating facilities are under high load or used at the time of disaster. The power generation system of the invention can be used in any mode.

In the above-described first, fourth and fifth embodiments, in a case where the electric power generated by the solar power generation device 200 in the cosmic space cannot be terrestrially transmitted by way of the electromagnetic waves of the microwave band at a predetermined transmission efficiency or above, the solar panel may be disposed on the upper end portion of the water tank 10 in place of the receiving antenna 30 so that the drainage pump is driven by using the electric power generated by the solar panel. Then, in a case where the electric power can be terrestrially transmitted from the solar power generation device 200 in the cosmic space at the predetermined transmission efficiency or above, it is also possible to replace the solar panel disposed on the upper end portion of the water tank with the receiving antenna 30.

While the above-described fourth and fifth embodiments have been described by way of example of the hollow shield tunnel 70 as the “fixing member” of the invention, an anchor member formed of concrete mass or iron mass may also be disposed in the bedrock as the fixing member.

The configuration and size of the above-described caisson are not limited to the above-described examples. The caisson may be formed in a rectangular parallelepiped configuration or a spherical configuration in accordance with the scale or structure of the power generation system. The caisson may also be changed in size. Further, the number of caissons forming the water tank may also be changed as necessary in accordance with the scale or configuration of the power generation system.

Further, the water tank may be disposed in a manner that a part thereof extends into the land. Needless to say, the water tank (caissons) may also be installed under water by deeply drilling the seafloor as shown in FIG. 7.

While the above-described fourth and fifth embodiments have been described by way of example of the caisson formed of iron, the structure of the caisson is not limited to the above-described example. For example, the caisson may be formed of concrete or of a combination of iron and concrete.

The above-described power generation system may be further provided with a transmitting antenna for transmitting the electromagnetic waves of the microwave band such that the electric power generated by the generator is converted to the electromagnetic waves of the microwave band which are transmitted by means of the transmitting antenna.

If such a configuration is made, the electric power generated by the power generation system can be transmitted to another power generation system via the transmitting antenna by converting the electric power to the electromagnetic waves of the microwave band. The following effect can be achieved by, for example, placing reflection means for reflecting the electromagnetic waves of the microwave band, such as a reflecting mirror or reflector antenna, in the cosmic space. Specifically, the electric power generated by the power generation system can be transmitted to another power generation system in a remote location by transmitting the electromagnetic waves of the microwave band by means of the transmitting antenna and delivering the electromagnetic waves of the microwave band to the other power generation system in the remote location by means of the reflection means in the cosmic space.

The transmitting antenna may be disposed on the upper end portion of the water tank the same way as the receiving antenna and the solar panel. Otherwise, the transmitting antenna may be disposed on the ground or on the sea in adjoining relation with the water tank.

Further, the electric power generated by the other power generation device, for example, can be converted to the electromagnetic waves of the microwave band and transmitted, while the electric power can be generated by receiving the transmitted electromagnetic waves of the microwave band by means of the receiving antenna and used to drive the drainage pump. If such a configuration is made, the electric power generated by the other power generation device can be stored in the power generation system.

In the case where the reflection means for reflecting the electromagnetic waves of the microwave band, such as a reflecting mirror or reflector antenna, is installed in the cosmic space, the following effect can be achieved. Specifically, the electric power generated by another power generation system in the remote location, as the other power generation device, is converted to the electromagnetic waves of the microwave band and transmitted. The electric power is generated by receiving the transmitted electromagnetic waves by the receiving antenna of this power generation system via the reflection means installed in the cosmic space and used to drive the drainage pump. Thus, the electric power generated by the power generation system in the remote location can be stored in this power generation system.

As described above, the counterpart power generation device which exchanges the electric power with the power generation system of the invention by transmitting/receiving the electromagnetic waves of the microwave band to/from the power generation system of the invention by means of the receiving antenna and the transmitting antenna may be a power generation device similar to the power generation system of the invention, a power generation device which generates the electric power by nuclear power generation, thermal power generation, hydroelectric power generation or the like, or a power generation device which generates the electric power by using any of the variety of renewable energies. The power generation device as the counterpart for electric power transmission may have any power generation principle. By using the receiving antenna and transmitting antenna, the electric power can be transmitted between a variety of power generation devices such as the power generation devices, including the power generation system of the invention, which generate the electric power from nuclear power generation, thermal power generation, hydroelectric power generation or the like, and the power generation devices which generate the electric power by using a variety of renewable energies.

While the above-described embodiments illustrate the example where the water tank has the upper end exposed from the water surface, the water tank may be disposed under water. In this case, it is preferred that there is a difference between the water level in the water tank and the water level outside the water tank.

### INDUSTRIAL APPLICABILITY

The present invention can be widely applied to a hydroelectric power generation technique which stores a large amount electric power and provides a stable power supply as necessary. Further, the present invention can be widely applied to technology for protection against tsunami and storm surge, technologies related to the emergency power source for a variety of power plants, technology for electric power transmission to/from a remote location and the like. Further, the present invention can be widely applied to a technique for terrestrial utilization of the electric power generated by the solar power generation device installed in the cosmic space.

### REFERENCE SIGNS LIST

1, 1a, 1b, 1c: POWER GENERATION SYSTEM
10: WATER TANK
10a: AUXILIARY WATER TANK
11: COMMUNICATION PASSAGEWAY
11a: FLOW PASSAGE
12: OPENING
20: GENERATOR (DRAINAGE PUMP)
20a: AUXILIARY GENERATOR
30: RECEIVING ANTENNA
40: CAISSON
42: INNER FACE
43: OUTER FACE
44: REINFORCING STRUCTURE
45: SLIDE DOOR (COVER MEMBER)
50: ELASTIC MEMBER
70: SHIELD TUNNEL
71: CONNECTING MEMBER
100: NUCLEAR POWER PLANT
200: SOLAR POWER GENERATION DEVICE
BR: BEDROCK
SS: SEA SURFACE (WATER SURFACE)
US: UNDER THE SEA (UNDER WATER)

1. A power storage system comprising:
a water tank installed under water and having a predetermined capacity;
a communication passageway formed for communication between the inside and the outside of the water tank; and
a generator disposed at the communication passageway,
wherein the generator generates electric power by using a hydraulic power of water flowing into the water tank via the communication passageway.

2. The power storage system according to claim 1, wherein the water tank is installed under water with an upper end portion thereof exposed from water surface,
the communication passageway is formed in the vicinity of a bottom of the water tank, and
the generator is driven by a difference between water pressures in the water tank and at the outside of the water tank.

3. The power storage system according to claim 1, further comprising a drainage pump for discharging the water from the water tank to the outside.

4. The power storage system according to claim 3,
further comprising a receiving antenna for receiving electromagnetic waves of a microwave band,
wherein the drainage pump is driven by an electric power generated from the electromagnetic waves of the microwave band which are transmitted from a power generation device and received by the receiving antenna.

5. The power storage system according to claim 4,
wherein the receiving antenna is disposed on an upper end portion of the water tank, which is exposed from water surface.

6. The power storage system according to claim 3, wherein the drainage pump is driven by an electric power generated from a renewable energy.

7. The power storage system according to claim 6, wherein the renewable energy is solar light or wind power.

8. The power storage system according to claim 7, wherein a solar panel for generating electric power from the solar light is disposed on an upper end portion of the water tank, which is exposed from water surface.

9. The power storage system according to claim 3, wherein the drainage pump is driven by an electric power from nuclear power generation.

10. The power storage system according to claim 3, wherein a plurality of communication passageways are formed in a direction of a height of the water tank and each of the communication passageways is provided with the generator.

11. The power storage system according to claim 1, further comprising:
an auxiliary water tank installed under water in the vicinity of the water tank as a main water tank;
a flow passage formed for communication between the inside and the outside of the auxiliary water tank; and
an auxiliary generator which is disposed at the flow passage in relation to the generator at the main water tank as a main generator and which is driven by a difference between water pressures in the auxiliary water tank and at the outside of the auxiliary water tank,
wherein when water is stored in the main water tank to above a predetermined water level and an output power from the main generator falls below a predetermined power level, the auxiliary generator generates electric power according to a difference between a pressure on the water surface in the auxiliary tank and a pressure on the water surface outside the auxiliary tank.

12. The power storage system according to claim 1, wherein the power storage system is used as an emergency power source for a nuclear power plant.

13. The power storage system according to claim 1, wherein an opening is formed at an upper end portion of the water tank.

14. The power storage system according to claim 13, further comprising a cover member for openably closing the opening.

15. The power storage system according to claim 1,
wherein the water tank is formed of a caisson, and
cross sections of the caisson orthogonal to an inner face and an outer face thereof each have a reinforcing structure where a plurality of polygons are arranged.

16. The power storage system according to claim 15, wherein the water tank is formed by mutually communicating spaces in the plural caissons.

17. The power storage system according to claim 16, wherein the plural caissons are arranged with a predetermined spacing therebetween,
the power storage system further comprises an elastic member interposed between the caissons, and
each space between the caissons is sealed with the elastic member.

18. The power storage system according to claim 1, further comprising:
a fixing member disposed in bedrock under the water tank; and
a connecting member for connecting the fixing member with the water tank.

19. The power storage system according to claim 1, further comprising a transmitting antenna for transmitting electromagnetic waves of a microwave band,
wherein electric power generated by the generator is converted to the electromagnetic waves of the microwave band, which are transmitted by means of the transmitting antenna.

20. (canceled)

21. The power storage system according to claim 2,
further comprising a drainage pump for discharging the water from the water tank to the outside.
